(19) United States
(12) Patent Application Publication
(10) Pub. No.: US 2026/0045191 A1
(43) Pub. Date: Feb. 12, 2026

(54) Electronic device and display device with backup signal generation

(71) Applicant: InnoLux Corporation, Miao-Li County (TW)

(72) Inventors: Hung-Kun CHEN, Miao-Li County (TW); Chung-Le CHEN, Miao-Li County (TW); Katsuhisa FUNAKOSHI, Miao-Li County (TW); Ting-Yao CHU, Miao-Li County (TW)

(73) Assignee: InnoLux Corporation, Miao-Li County (TW)

(21) Appl. No.: 19/258,902

(22) Filed: Jul. 3, 2025

(30) Foreign Application Priority Data
Aug. 9, 2024 (CN) 202411087956.X

(51) Int. Cl. G09G 3/20

(52) U.S. Cl. CPC G09G 3/20; G09G 2310/0221; G09G 2310/0267; G09G 2310/0275; G09G 2330/08

(57) ABSTRACT

An electronic device has a substrate, a first scan driving element, a first scan line, and a first switch element. The substrate has an active area and a peripheral area adjacent to the active area. The first scan driving element is arranged in a first region of the peripheral area. The first scan line is electrically connected to the first scan driving element. The first switch element is arranged in the peripheral area and electrically connected to the first scan line. When the electronic device is under a first condition, the first scan driving element provides a first scan signal to the first scan line. When the electronic device is under a second condition, the first switch element is turned on to transmit a second scan signal to the first scan line.

### BACKGROUND OF THE DISCLOSURE

### 1. Field of the Disclosure

This disclosure relates to an electronic device, particularly to a multi-screen electronic device.

### 2. Description of the Prior Art

In a multi-panel display, the electronic elements (e.g., pixels) within the active regions of different sections are controlled by driving circuits located on opposite sides. When a driving circuit on one side of the multi-panel display malfunctions, it is unable to properly drive the electronic elements (e.g., pixels) in the corresponding active region (e.g., discharging the elements to insert a black frame), thus causing visual disturbances for the user.

### SUMMARY OF THE DISCLOSURE

In accordance with certain embodiments, the present disclosure provides an electronic device comprising a substrate, a first scan driving element, a first scan line, and a first switch element. The substrate comprises an active area and a peripheral area adjacent to the active area. The first scan driving element is disposed on a first region of the peripheral area. The first scan line is electrically connected to the first scan driving element. The first switch element is disposed on the peripheral area and electrically connected to the first scan line. When the electronic device is under a first condition, the first scan driving element provides a first scan signal to the first scan line. When the electronic device is under a second condition, the first switch element is turned on to transmit a second scan signal to the first scan line.

In accordance with some embodiments, the present disclosure provides a display device comprising a substrate, a first scan driving element, a first scan line, and a first switch element. The substrate comprises an active area and a peripheral area adjacent to the active area. The first scan driving element is disposed on a first region of the peripheral area. The first scan line is electrically connected to the first scan driving element. The first switch element is disposed on the peripheral area and electrically connected to the first scan line. When the electronic device is under a first condition, the first scan driving element provides a first scan signal to the first scan line. When the electronic device is under a second condition, the first switch element is turned on to transmit a second scan signal to the first scan line.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1A to FIG. 1C are schematic diagrams of an electronic device according to one embodiment of the present disclosure.

FIG. 2 to FIG. 6 are schematic diagrams of electronic devices according to different embodiments of the present disclosure.

### DETAILED DESCRIPTION

The present disclosure may be understood by referring to the following detailed description and accompanying drawings. It should be noted that, to facilitate understanding by the reader and simplify the drawings, only a portion of the electronic device is illustrated in the accompanying drawings, and the specific components in the drawings are not drawn to scale. In addition, the number and size of the components in the drawings are illustrative only and are not intended to limit the scope of the disclosure.

Certain terms are used throughout the specification and the appended claims to refer to particular components. It will be understood by those skilled in the art that electronic device manufacturers may refer to the same component with different names. The present specification is not intended to distinguish between components that have the same function but different names.

As used in the specification and the claims, the terms “comprising,” “including,” “having,” and variations thereof are to be construed as open-ended terms and mean “including, but not limited to.” Thus, when the specification states that a device or method “comprises,” “includes,” or “has” a certain feature, element, step, operation, or component, this means that the described device or method includes at least the listed feature, element, step, operation, or component, but does not exclude the presence of one or more other features, elements, steps, operations, or components.

Directional terms used herein, such as “upper,” “lower,” “front,” “rear,” “left,” and “right,” are merely for convenience of description. Thus, the directional terms are used for descriptive purposes and are not intended to limit the disclosure. The figures illustrate the typical features of methods, structures, and/or materials used in the specific embodiments. However, these figures should not be construed to define or limit the scope or nature of the subject matter covered by these embodiments. For example, for clarity, the relative sizes, thicknesses, and positions of various layers, regions, and/or structures may be exaggerated or minimized.

When a component (such as a layer or region) is said to be “on” another, it can be directly on the other or there can be intervening components between the two. On the other hand, when a component is said to be “directly on” another, there are no intervening components between the two. Further, when a component is said to be “on” another, the two have a vertical relationship, and the component can be above or below the other, depending on the orientation of the device.

It should be understood that when a component or layer is said to be “connected to” another component or layer, it can be directly connected to the other component or layer, or there can be intervening components or layers. When a component is said to be “directly connected to” another component or layer, there are no intervening components or layers between the two. Further, when a component is said to be “electrically connected to” another component (or variations thereof), it can be directly connected to the other component, or it can be indirectly connected (e.g., electrically coupled) to the other component through one or more intervening components.

In the present disclosure, when a component is “electrically connected” to another component, an electrical signal can flow between the two components at least at some point during normal operation; and when a component is “electrically coupled” to another component, an electrical signal can flow between the two components during a specified period. In the present disclosure, when a component is “disconnected” from another component, an electrical signal cannot flow between the two components during a specified period.

The terms “approximately” or “substantially” are generally interpreted as being within plus/minus 20% of a given value, or as being within plus/minus 10%, plus/minus 5%, plus/minus 3%, plus/minus 2%, plus/minus 1%, or plus/minus 0.5% of a given value.

The use of ordinal terms such as “first,” “second,” and the like to modify the elements in the specification and claims is intended solely to distinguish one element having that designation from another element having the same designation. The use of these ordinal terms does not imply any particular order or sequence with respect to the elements. Thus, a first element in the specification may be a second element in the claims.

It should be understood that the foregoing embodiments are illustrative of the principles of the present disclosure and are not intended to be exhaustive. Other embodiments may be devised which incorporate the features of the embodiments described herein without departing from the spirit and scope of the disclosure.

In this disclosure, the electronic device may include, but is not limited to, a display device, a light emitting device, a backlight device, a virtual reality device, an augmented reality (AR) device, an antenna device, a sensing device, a splicing device, or any combination thereof. The display device may be a non-emissive display or an emissive display depending on the requirements, and may be a color display or a monochrome display depending on the requirements. The antenna device may be a liquid crystal type antenna device or a non-liquid crystal type antenna device, and the sensing device may be a sensor for sensing capacitance, light, thermal energy, or ultrasonic waves. The splicing device may be a display splicing device or an antenna splicing device, but is not limited thereto.

The electronic device may comprise passive components and active components such as capacitors, resistors, inductors, diodes, and transistors. Diodes may include light emitting diodes (LEDs) or photodiodes. LEDs may include, for example, organic light emitting diodes (OLEDs), mini-LEDs, micro-LEDs, or quantum dot LEDs, but are not limited thereto. Transistors may include, for example, top-gate thin-film transistors,, bottom-gate thin-film transistors, or dual-gate thin-film transistors, but are not limited thereto. The electronic device may also include, depending on the requirements, fluorescent materials, phosphorescent materials, quantum dot (QD) materials, or other suitable materials. The electronic device may have peripheral systems such as a driving system, a control system, a light source system, and so on to support display devices, antenna devices, wearable devices (such as augmented reality or virtual reality devices), in-vehicle devices (such as car windshields), or splicing devices.

In some embodiments, an electronic panel may be a type of electronic device, and the electronic panel may be at least a combination of a display device and a touch sensing device, so that the electronic panel has at least a display function and a touch sensing function. In the following description, the electronic device is used as an example to illustrate this disclosure, but the design of this disclosure can be applied to any suitable electronic device.

Furthermore, the switch element described in this disclosure can be any electronic component having a switching function. For example, the switch element can be a thin-film transistor. For example, the thin-film transistor can be a top-gate transistor, a bottom-gate transistor, a dual-gate transistor, or other suitable types of transistors.

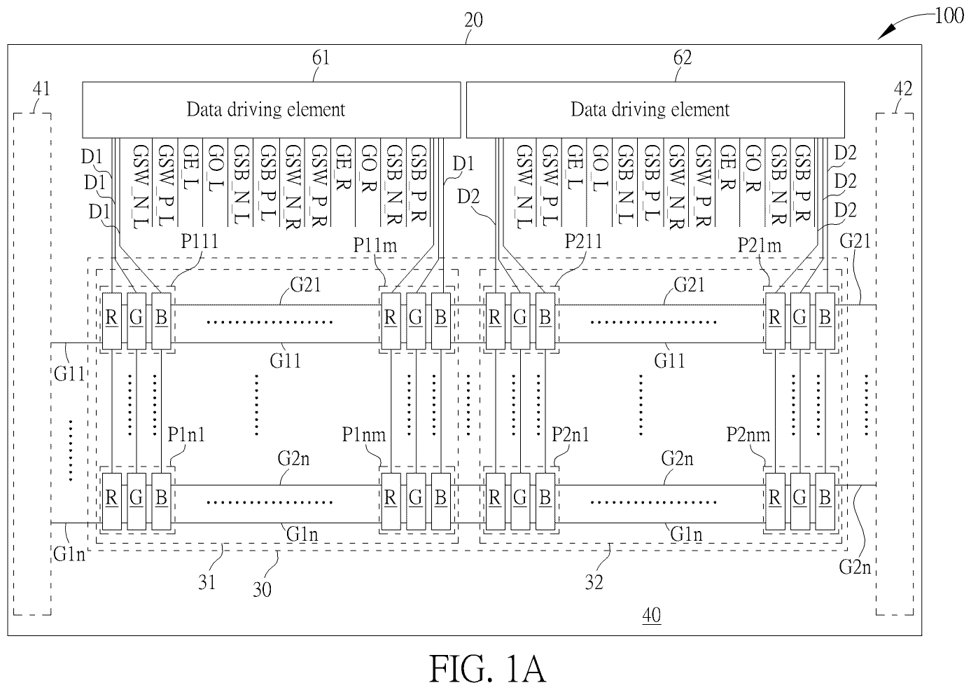

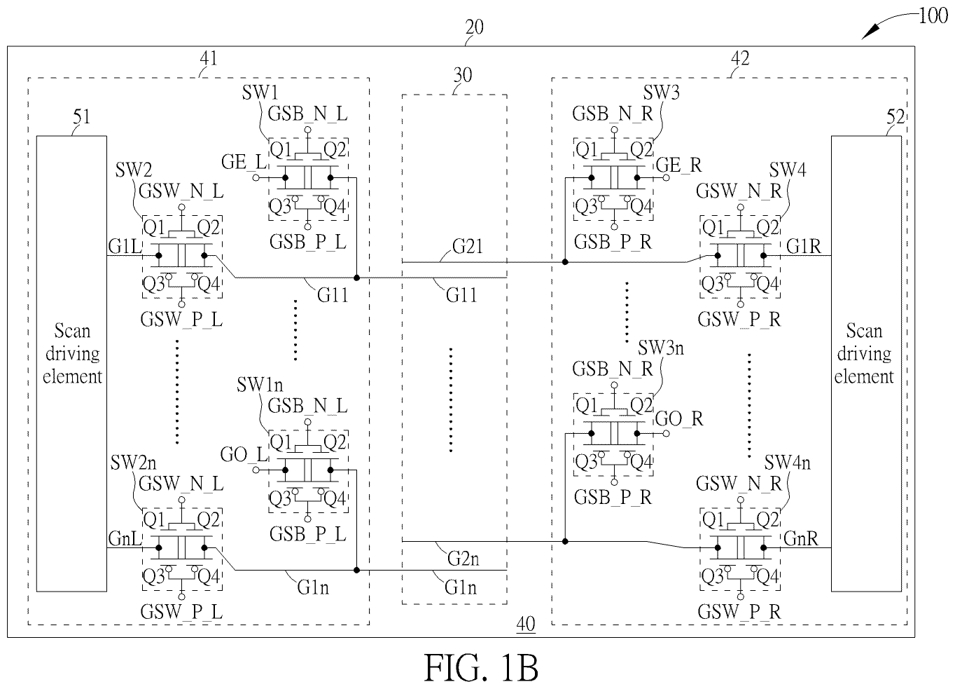

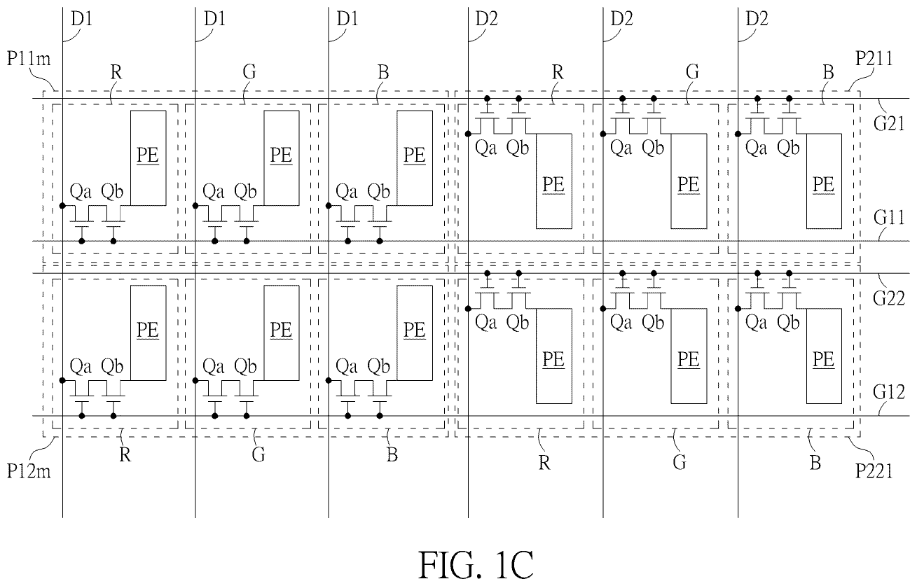

Please refer to FIG. 1A to FIG. 1C. FIG. 1A to FIG. 1C are schematic diagrams of an electronic device 100 according to one embodiment of the present disclosure. In order to clearly illustrate the important components and signals of the electronic device 100 in FIG. 1A to FIG. 1C, FIG. 1A illustrates an active area 30 and the two data driving elements 61 and 62 of the electronic device 100, FIG. 1B illustrates a first region 41 and a second region 42 of a peripheral area 40 of the electronic device 100, and FIG. 1C illustrates four electronic units of the electronic device 100, such as four pixels P11m, P12m, P211, and P221, and their circuits. The electronic device 100 may be a display device and may comprise a substrate 20, a scan driving element 51, scan lines G11 to G1n, switch elements SW1 to SW4 and switch elements SWin to SW4n, a scan driving element 52, and scan lines G21 to G2n. The substrate 20 comprises the active area 30 and the peripheral area 40 adjacent to the active area 30. In the embodiment, the peripheral area 40 is, for example, the area of the substrate 20 other than the active area 30. As shown in FIG. 1A to FIG. 1C, the electronic device 100 may further comprise a plurality of pixels P111 to P1nm and pixels P211 to P2nm disposed on the active area 30, and data driving elements 61 and 62 disposed on the peripheral area 40. The pixels P111 to P1nm are disposed on a first region 31 of the active area 30 and are electrically connected to the data driving element 61 via data lines D1, while the pixels P211 to P2nm are disposed on a second region 32 of the active area 30 and are electrically connected to the data driving element 62 via data lines D2. The pixels P111 to P1nm are arranged in, for example, m columns and n rows, and the pixels P211 to P2nm are also arranged in m columns and n rows, where m and n are integers greater than 1, but are not limited thereto. Each data line D1 extends from the peripheral area 40 to the first region 31 of the active area 30 and is electrically connected to the data driving element 61, and each data line D2 extends from the peripheral area 40 to the second region 32 of the active area 30 and is electrically connected to the data driving element 62.

Each pixel may comprise three sub-pixels, R, G, and B, representing red, green, and blue sub-pixels, respectively, but is not limited thereto, and may comprise sub-pixels of other colors depending on the design. As shown in FIG. 1C, each sub-pixel R, G, or B may be, for example, a sub-pixel with a dual-gate structure, and may comprise an N-type transistor Qa, an N-type transistor Qb, and a pixel electrode PE, but is not limited thereto. The gates of the two N-type transistors Qa and Qb of each sub-pixel R, G, or B are electrically connected to a corresponding scan line. For example, the gates of the two N-type transistors Qa and Qb of each sub-pixel R, G, and B of the pixel P11m are electrically connected to the scan line G11, the gates of the two N-type transistors Qa and Qb of each sub-pixel R, G, and B of the pixel P211 are electrically connected to the scan line G21, the gates of the two N-type transistors Qa and Qb of each sub-pixel R, G, and B of the pixel P12m are electrically connected to the scan line G12, and the gates of the two N-type transistors Qa and Qb of each sub-pixel R, G, and B of the pixel P221 are electrically connected to the scan line G22, but are not limited thereto. In addition, one end of the N-type transistor Qa in each sub-pixel R, G, and B of each pixel P111 to P1nm (e.g., pixels P11m to P12m in FIG. 1C) disposed on the first region 31 of the active area 30 is electrically connected to a corresponding data line D1, while one end of the N-type transistor Qa in each sub-pixel R, G, and B of each pixel P211 to P2nm (e.g., pixels P211 to P221 in FIG. 1C) disposed on the second region 32 of the active area 30 is electrically connected to a corresponding data line D2. The two ends of the N-type transistor Qb are electrically connected to the other end of the N-type transistor Qa and the pixel electrode PE, respectively.

In other embodiments of the present disclosure, the N-type transistor Qb of each sub-pixel R, G, and B may be omitted, and the two ends of each N-type transistor Qa are electrically connected to a data line (D1 or D2) and the pixel electrode PE, respectively.

As shown in FIG. 1A and FIG. 1B, the scan driving element 51 is disposed on the first region 41 of the peripheral area 40, while the scan driving element 52 is disposed on the second region 42 of the peripheral area 40. The scan driving element 51 is configured to generate scan signals G1L to GnL and to transmit the scan signals G1L to GnL to the sub-pixels R, G, and B in the first region 31 of the active area 30 through the scan lines G11 to G1n. The scan driving element 52 is configured to generate scan signals G1R to GnR and to transmit the scan signals G1R to GnR to the sub-pixels R, G, and B in the second region 32 of the active area 30 through the scan lines G21 to G2n. Specifically, the scan signal G1L is transmitted through the scan line G11, the scan signal GnL is transmitted through the scan line G1n, the scan signal GIR is transmitted through the scan line G21, the scan signal GnR is transmitted through the scan line G2n, and so on. The scan lines G11 to Gin are electrically connected to the scan driving element 51, and the scan lines G21 to G2n are electrically connected to the scan driving element 52. Additionally, the scan lines G11 to Gn may extend from the first region 31 of the active area 30 to the second region 32 of the active area 30, and the scan lines G21 to G2n may extend from the second region 32 of the active area 30 to the first region 31 of the active area 30.

The switch elements SW1 to SW1n and SW2 to SW2n of the electronic device 100 are disposed on the first region 41 of the peripheral area 40 and are electrically connected to the scan lines G11 to G1n, while the switch elements SW3 to SW3n and SW4 to SW4n of the electronic device 100 are disposed on the second region 42 of the peripheral area 40 and are electrically connected to the scan lines G21 to G2n. The switch elements SW2 to SW2n are disposed on the first region 41 of the peripheral area 40 and are electrically connected between the scan driving element 51 and the scan lines G11 to G1n, while the switch elements SW4 to SW4n are disposed on the second region 42 of the peripheral area 40 and are electrically connected between the scan driving element 52 and the scan lines G21 to G2n. Each of the switch elements SW1 to SW1n, SW2 to SW2n, SW3 to SW3n, and SW4 to SW4n may have, for example, an N-type transistor Q1 and an N-type transistor Q2, and a P-type transistor Q3 and a P-type transistor Q4 electrically connected in a dual-gate structure (as shown in FIG. 1B), but is not limited thereto.

Each of the switch elements SW1 to SW1n has two control ends, respectively receiving signals GSB_N_L and GSB_P_L. Similarly, each of the switch elements SW2 to SW2n has two control ends, respectively receiving signals GSW_N_L and GSW_P_L. Each of the switch elements SW3 to SW3n has two control ends, respectively receiving signals GSB_N_R and GSB_P_R. Each of the switch elements SW4 to SW4n has two control ends, respectively receiving signals GSW_N_R and GSW_P_R. In detail, one of the two control ends of each of the switch elements SW1 to SW1n is the coupled gates of the N-type transistors Q1 and Q2 for receiving the signal GSB_N_L, and the other control end of each of the switch elements SW1 to SW1n is the coupled gates of the P-type transistors Q3 and Q4 for receiving the signal GSB_P_L. Similarly, one of the two control ends of each of the switch elements SW2 to SW2n is the coupled gates of the N-type transistors Q1 and Q2 for receiving the signal GSW_N_L, and the other control end of each of the switch elements SW2 to SW2n is the coupled gates of the P-type transistors Q3 and Q4 for receiving the signal GSW_P_L. One of the two control ends of each of the switch elements SW3 to SW3n is the coupled gates of the N-type transistors Q1 and Q2 for receiving the signal GSB_N_R, and the other control end of each of the switch elements SW3 to SW3n is the coupled gates of the P-type transistors Q3 and Q4 for receiving the signal GSB_P_R. One of the two control ends of each of the switch elements SW4 to SW4n is the coupled gates of the N-type transistors Q1 and Q2 for receiving the signal GSW_N_R, and the other control end of each of the switch elements SW4 to SW4n is the coupled gates of the P-type transistors Q3 and Q4 for receiving the signal GSW_P_R.

The data driving elements 61 and 62 provide the signals GSW_N_L, GSW_P_L, GE_L, GO_L, GSB_N_L, GSB_P_L, GSW_N_R, GSW_P_R, GE_R, GO_R, GSB_N_R, and/or GSB_P_R, but are not limited to these signals. Therefore, even if one of the data driving elements 61 and 62 fails, the other data driving element can still transmit the signals GSW_N_L, GSW_P_L, GE_L, GO_L, GSB_N_L, GSB_P_L, GSW_N_R, GSW_P_R, GE_R, GO_R, GSB_N_R, and/or GSB_P_R to the switch elements on the failed side of the electronic device 100. For example, when the data driving element 61 fails, the signals GSW_N_L, GSW_P_L, GE_L, GO_L, GSB_N_L, and/or GSB_P_L generated by the data driving element 62 will be transmitted to the switch elements SW1 to SW1n and SW2 to SW2n on the left side of the electronic device 100. The signals provided to the control ends of the switch elements SW1 to SW1n and SW2 to SW2n are provided by one of the data driving elements 61 and 62 (e.g., the non-failed data driving element 62). Similarly, when the data driving element 62 fails, the signals GSW_N_R, GSW_P_R, GE_R, GO_R, GSB_N_R, and/or GSB_P_R generated by the data driving element 61 will be transmitted to the switch elements SW3 to SW3n and SW4 to SW4n on the right side of the electronic device 100. The signals provided to the control ends of the switch elements SW3 to SW3n and SW4 to SW4n are provided by one of the data driving elements 61 and 62 (e.g., the non-failed data driving element 61).

TABLE 1

| | Normal | Condition when the data |
|---|---|---|
| Signal or component | condition | driving element 61 fails |
| GSW_N_L | VH | GND or (VL to VH) |
| | | (provided by the data driving |
| | | element on the non-failed side) |
| GSW_P_L | VL | VL to VH |
| | | (provided by the data driving |
| | | element on the non-failed side) |
| SW2 to SW2n | ON | OFF |
| GSW_N_R | VH | VH |
| GSW_P_R | VL | VL |
| SW4 to SW4n | ON | ON |
| GSB_N_L | VL | GND or (VL to VH) |
| | | (provided by the data driving |
| | | element on the non-failed side) |
| GSB_P_L | VH | GND or (VL to VH) |
| | | (provided by the data driving |
| | | element on the non-failed side) |
| SW to SW1n | OFF | ON |
| GSB_N_R | VL | VL |
| GSB_P_R | VH | VH |
| SW3 to SW3n | OFF | OFF |
| GE_L | GND | VL to VH |
| | | (provided by the data driving |
| | | element on the non-failed side) |
| GO_L | GND | VL to VH |
| | | (provided by the data driving |
| | | element on the non-failed side) |
| G1L to GnL and | VL to VH | VL to VH |
| G1R to GnR | | |
| G11 | VL to VH | VL to VH |
| | (G1L) | (GE_L) |
| G1n | VL to VH | VL to VH |
| | (GnL) | (GO_L) |
| G21 | VL to VH | VL to VH |
| | (G1R) | (G1R) |
| G2n | VL to VH | VL to VH |
| | (GnR) | (GnR) |
| D1 | VdataL to | GND |
| | VdataH | |
| D2 | VdataL to | VdataL to VdataH |
| | VdataH | |
| The common electrode | VCOM | GND |
| of the pixels in the | | |
| first region | | |

The following describes the cases where both the data driving element 61 and the data driving element 62 continue to function normally and where the data driving element 61 fails, respectively. Please refer to Table 1. When both the data driving element 61 and the data driving element 62 continue to function normally, the electronic device 100 is in a normal state (i.e., the first condition which is the normal condition), and the signals GSW_N_L, GSW_N_R, GSB_P_L, and GSB_P_R are, for example, all at a high voltage VH, and the signals GSW_P_L, GSW_P_R, GSB_N_L, and GSB_N_R are, for example, all at a low voltage VL, causing the switch elements SW2 to SW2n and SW4 to SW4n to be turned on, and the switch elements SW1 to SW1n and/or SW3 to SW3n to be turned off, so that the scan signals G1L to GnL generated or provided by the scan driving element 51 may be transmitted to the corresponding scan lines G11 to G1n through the switch elements SW2 to SW2n, respectively. That is, under the normal condition (i.e., the first condition), the scan driving element 51 provides the scan signals G1L to GnL to the scan lines G11 to G1n. Similarly, under the normal condition (i.e., the first condition), the scan signals G1R to GnR generated by the scan driving element 52 may be transmitted to the corresponding scan lines G21 to G2n through the switch elements SW4 to SW4n, respectively. That is, under the normal condition (i.e., the first condition), the scan driving element 52 provides the scan signals G1R to GnR to the scan lines G21 to G2n. At this time, the signals GE_L, GE_R, GO_L, and GO_R may be at ground voltage (GND), the common electrodes of the pixels P11m, P12m, P211, and P221 may be at a common voltage VCOM, and the data driving elements 61 and 62 transmit data voltages in the range of VdataL to VdataH to the pixels P11m, P12m, P211, and P221 through data lines D1 and D2, respectively. At this time, under the first condition (i.e., the normal condition), the pixels P11m and P12m are driven by the scan driving element 51, and the pixels 211 and P221 are driven by the scan driving element 52.

When the data driving element 61 fails, but the data driving element 62 continues to function normally, the electronic device 100 is in a failure state (i.e., the second condition). For example, the signals GSW_N_L and GSB_P_L are both at ground voltage GND, while the voltage of signals GSW_P_L, GE_L, and GO_L may be between a high voltage VH and a low voltage VL. The signals GSW_N_R and GSB_P_R are, for example, at a high voltage VH, and the signals GSW_P_R and GSB_N_R are, for example, at a low voltage VL. As a result, the switch elements SW1 to SW1n and SW4 to SW4n are turned on, while the switch elements SW2 to SW2n and SW3 to SW3n are turned off. When the data driving element 61 fails, but the data driving element 62 continues to function normally, in the failure state (i.e., the second condition) of the electronic device 100, the signals GE_L and GO_L generated or provided by the data driving element 62 may be used as scan signals and transmitted to the scan lines G11 to G1n through the opened switch elements SW1 to SW1n. In other words, the switch elements SW1 to SW1n are turned on to transmit the corresponding scan signals (e.g., the signals GE_L and GO_L) to the first scan lines G11 to G1n, respectively, and the corresponding scan signals (e.g., signals GE L and GO_L) are not provided by the scan driving element 51. When the data driving element 61 fails, but the data driving element 62 continues to function normally, in the failure state (i.e., the second condition) of the electronic device 100, the scan signals G1R to GnR generated by the scan driving element 52 can still be transmitted to the scan lines G21 to G2n through the switch elements SW4 to SW4n. At this time, the common electrode of the pixels may be at ground voltage GND, and the data driving element 61 transmits a ground voltage GND to the pixels P111 to P1nm through the data line D1. As a result, pixels P111 to P1nm, for example, display black, causing the electronic device 100 to display a black image in the first region 30 (left side). The data driving element 62 transmits data voltages in the range of VdataL to VdataH to the pixels P211 to P2nm through the data line D2, so the pixels P211 to P2nm can still display images normally. When the data driving element 61 fails, but the data driving element 62 continues to function normally, in the failure state (i.e., the second condition) of the electronic device 100, the switch elements SW1 to SW1n are turned on to transmit the scan signals to the scan lines G11 to G1n, respectively, to turn on the transistors (transistors Qa and/or transistors Qb) of the pixels P11m and P12m. The pixels P11m and P12m are not driven by the scan driving element 51, while the pixels 211 and P221 are driven by the scan driving element 52.

Since the data driving elements 61 and 62 generate signals GSW_N_L, GSW_P_L, GE_L, GO_L, GSB_N_L, GSB_P_L, GSW_N_R, GSW_P_R, GE_R, GO_R, GSB_N_R, and GSB_P_R, but are not limited thereto, even if one of the data driving elements 61 and 62 fails, the other data driving element can still generate or provide signals and transmit the signals GSW_N_L, GSW_P_L, GE_L, GO_L, GSB_N_L, GSB_P_L, GSW_N_R, GSW_P_R, GE_R, GO_R, GSB_N_R, and GSB_P_R to the switch elements on the failed side. Through the above method, when one of the data driving elements 61 and 62 fails, the pixels on the failed side display a black image, for example, while the pixels on the non-failed side can display images normally.

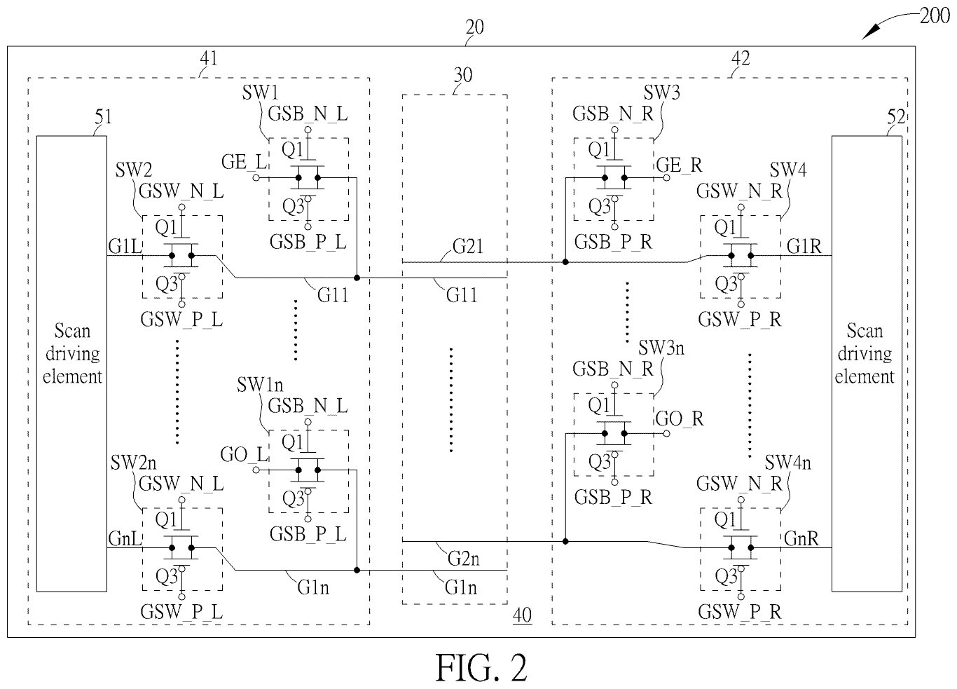

The above embodiment takes the case where the data driving element 61 fails, but the data driving element 62 continues to function normally as an example, and through the above description, those skilled in the art can deduce the operation mode when the data driving element 62 fails, but the data driving element 61 continues to function normally. In addition, in the above embodiment, each switch element SW1 to SW1n, SW2 to SW2n, SW3 to SW3n, and SW4 to SW4n may have an N-type transistor Q1, an N-type transistor Q2, a P-type transistor Q3 and a P-type transistor Q4. The two N-type transistors Q1 and Q2 are electrically connected in a dual-gate structure, and the two P-type transistors Q3 and Q4 are electrically connected in another dual-gate structure, but the present disclosure is not limited thereto. Referring to FIG. 2, FIG. 2 is a schematic diagram of another electronic device 200 according to the present disclosure. The difference between the electronic device 200 and the electronic device 100 is that each switch element SW1 to SW1n, SW2 to SW2n, SW3 to SW3n, and SW4 to SW4n of the electronic device 200 has an N-type transistor Q1 and a P-type transistor Q3, each of which is electrically connected in a single-gate structure. Except for the above differences, the circuit structure and operations of the electronic device 200 are the same as those of the electronic device 100, and therefore will not be reiterated.

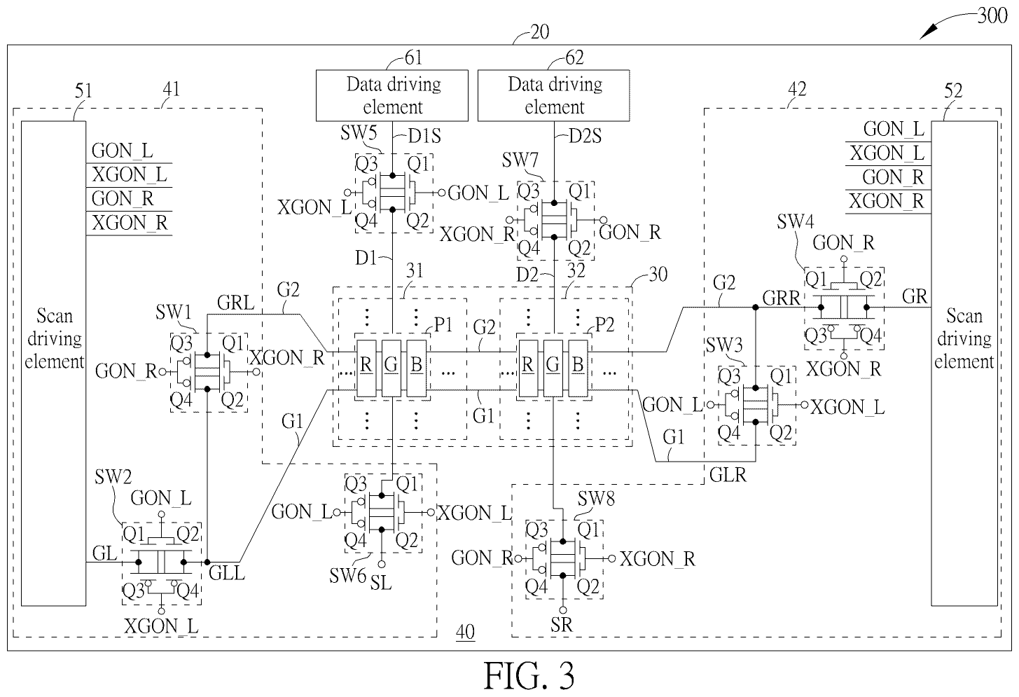

Please refer to FIG. 3, which is a schematic diagram of another electronic device 300 according to the present disclosure. The electronic device 300 may be a display device and may comprise a substrate 20, a scan driving element 51, a scan line G1, switch elements SW1 to SW8, a scan driving element 52, and a scan line G2. The substrate 20 has an active area 30 and a peripheral area 40 adjacent to the active area. In this embodiment, the peripheral area 40 is an area on the substrate 20 other than the active area 30. The electronic device 300 may further comprise a plurality of pixels (such as P1 and P2) disposed on the active area 30, and data driving elements 61 and 62 disposed on the peripheral area 40. The pixel P1 is disposed on the first region 31 of the active area 30 and is electrically connected to the data driving element 61 through a data line D1, and the pixel P2 is disposed on the second region 32 of the active area 30 and is electrically connected to the data driving element 62 through a data line D2. The first region 31 is adjacent to the second region 32, for example. The structure of the plurality of pixels disposed on the active area 30 of the electronic device 300 may be the same as the structure of the plurality of pixels of the electronic device 100 (as shown in FIG. 1C), and therefore will not be reiterated.

The scan driving element 51 is disposed on the first region 41 of the peripheral area 40, while the scan driving element 52 is disposed on the second region 42 of the peripheral area 40. The first region 41 and the second region 42 are disposed on opposite sides, for example. The scan driving element 51 is configured to generate a scan signal GL and to transmit the scan signal GL to the sub-pixels R, G, and B of the pixel P1 in the first region 31 of the active area 30 through the scan line G1, but is not limited thereto. The scan line G1 is electrically connected to the scan driving element 51, and the scan line G2 is electrically connected to the scan driving element 52. The scan driving element 52 is configured to generate or provide a scan signal GR and to transmit the scan signal GR to the sub-pixels R, G, and B of the pixel P2 in the second region 32 of the active area 30 through the scan line G2, but is not limited thereto. The scan line G1 can extend from the first region 41 of the peripheral area 40 to the active area 30 (e.g., the first region 31 and the second region 32), and one end of the scan line G1 is electrically connected to the scan driving element 51. The scan line G2 can extend from the second region 42 of the peripheral area 40 to the active area 30 (e.g., the second region 32 and the first region 31), and one end of the scan line G2 is electrically connected to the scan driving element 52. In addition, although FIG. 3 only illustrates two scan lines G1 and G2 and a corresponding row of pixels (including pixels P1 and P2), those skilled in the art can understand from the description of the present disclosure that the embodiment of FIG. 3 may be extended to a situation where the electronic device 300 comprises more scan lines and more rows of pixels.

The switch elements SW1 and SW2 of the electronic device 300 are disposed on the peripheral area 40 (e.g., the first region 41) and are electrically connected to the scan line G1, while the switch elements SW3 and SW4 of the electronic device 300 are disposed on the second region 42 of the peripheral area 40 and are electrically connected to the scan line G2. The switch element SW2 is disposed on the first region 41 of the peripheral area 40, and the switch element SW2 is electrically connected between the scan driving element 51 and the scan line G1. The signal (e.g., signal GON_L or signal XGN_L) of the control end of the switch element SW2 is provided by the scan driving element 52. The switch element SW4 is electrically connected between the scan driving element 52 and the scan line G2, and the signal (e.g., signal GON_R or signal XGN_R) of the control end of the switch element SW4 is provided by the scan driving element 51, but is not limited thereto. The switch element SW5 is electrically connected between the data driving element 61 and the data line D1, and the switch element SW7 is electrically connected between the data driving element 62 and the data line D2. One end of the switch element SW6 is electrically connected to the data line D1, and the other end of the switch element SW6 receives the signal SL. One end of the switch element SW8 is electrically connected to the data line D2, and the other end of the switch element SW8 receives the signal SR.

Each of the switch elements SW1 to SW8 may have two N-type transistors Q1 and Q2 and two P-type transistors Q3 and Q4. The two N-type transistors Q1 and Q2 are electrically connected in a dual-gate structure, and the two P-type transistors Q3 and Q4 are electrically connected in another dual-gate structure, but the present disclosure is not limited thereto. The switch elements SW1, SW4, SW7, and SW8 each have two control ends that respectively receive signals GON_R and XGON_R, while the switch elements SW2, SW3, SW5, and SW6 each have two control ends that respectively receive signals GON_L and XGON_L. More specifically, the two control ends of the switch elements SW1 and SW8 are the gates of the N-type transistors Q1 and Q2 for receiving the signal XGON_R, and the gates of the P-type transistors Q3 and Q4 for receiving the signal GON_R. The two control ends of the switch elements SW2 and SW5 are the gates of the N-type transistors Q1 and Q2 for receiving the signal GON_L, and the gates of the P-type transistors Q3 and Q4 for receiving the signal XGON_L. The two control ends of the switch elements SW3 and SW6 are the gates of the N-type transistors Q1 and Q2 for receiving the signal XGON_L, and the gates of the P-type transistors Q3 and Q4 for receiving the signal GON_L. The two control ends of the switch elements SW4 and SW7 are the gates of the N-type transistors Q1 and Q2 for receiving the signal GON_R, and the gates of the P-type transistors Q3 and Q4 for receiving the signal XGON_R. However, the present disclosure is not limited thereto.

The scan driving elements 51 and 52 respectively generate or provide signals GON_L, XGON_L, GON_R, and XGON_R. Therefore, even if one of the scan driving elements 51 or 52 fails, the other scan driving element (the non-failed scan driving element) can still generate or provide control signals, transmitting signals GON_L, XGON_L, GON_R, and XGON_R to the switch elements on the failed side. For example, when the scan driving element 51 fails, but the scan driving element 52 continues to function normally, the signals GON_L, XGON_L, GON_R, and XGON_R generated by the scan driving element 52 will be transmitted to the switch elements SW1, SW2, SW5, and SW6 on the left side (i.e., the first region 41), controlling the on/off state of these switch elements SW1, SW2, SW5, and SW6. That is, the signals (signals GON_L, XGON_L, GON_R, and XGON_R) at the control ends of the switch elements SW1, SW2, SW5, and SW6 are provided by the scan driving element 52, but are not limited to this configuration. Similarly, when the scan driving element 52 fails, but the scan driving element 51 continues to function normally, the signals GON_L, XGON_L, GON_R, and XGON_R generated by the scan driving element 51 will be transmitted to the switch elements SW3, SW4, SW7, and SW8 on the right side (i.e., the second region 42), controlling the on/off state of these switch elements SW3, SW4, SW7, and SW8. That is, the signals (signals GON_L, XGON_L, GON_R, and XGON_R) at the control ends of the switch elements SW3, SW4, SW7, and SW8 are provided by the scan driving element 51, but are not limited to this configuration.

TABLE 2

| | | Failure condition |
|---|---|---|
| Signal or component | Normal condition | (Failed on left side) |
| GON_L | VH | VL |
| XGON_L | VL | VH |
| GON_R | VH | VH |
| XGON_R | VL | VL |
| SW1 and SW8 | OFF | OFF |
| SW2 and SW5 | ON | OFF |
| SW3 and SW6 | OFF | ON |
| SW4 and SW7 | ON | ON |
| D1S | VdataL to VdataH | GND |
| D2S | VdataL to VdataH | VdataL to VdataH |
| D1 | VdataL to VdataH | SL |
| D2 | VdataL to VdataH | VdataL to VdataH |
| GL | VL to VH | GND |
| GR | VL to VH | VL to VH |
| GLL | VL to VH | GR (VL to VH) |
| GLR | VL to VH | GR (VL to VH) |
| GRR | VL to VH | GR (VL to VH) |
| GRL | VL to VH | GR (VL to VH) |
| SL and SR | VCOM or GND | VCOM or GND |
| | (discharge voltage) | (discharge voltage) |

Taking the electronic device 300 as an example, let's illustrate the scenarios where scanning driver component 51 fails, but both scanning driver components 51 and 52 continue to function normally. Please refer to Table 2. When both scan driving elements 51 and 52 continue to function normally (i.e., in the first condition), the electronic device 300 is in a normal state. The signals GON_L and GON_R are, for example, at a high voltage level VH, and the signals XGON_L and XGON_R are, for example, at a low voltage level VL. This causes the switch elements SW2, SW4, SW5, and SW7 to be turned on, and the switch elements SW1, SW3, SW6, and SW8 to be turned off. Consequently, the scan signal GL generated or provided by the scan driving element 51 may be transmitted to the scan line G1 through the switch element SW2, and the scan signal GR generated or provided by the scan driving element 52 may be transmitted to the scan line G2 through the switch element SW4. Moreover, the data signal DIS generated or provided by the data driving element 61 may be transmitted to the data line D1 through the switch element SW5, and the data signal D2S generated or provided by the data driving element 62 may be transmitted to the data line D2 through the switch element SW7.

The left-side voltage GLL and the right-side voltage GLR are, for example, equivalent to the voltage of the scan signal GL, while the right-side voltage GRR and the left-side voltage GRL are, for example, equivalent to the voltage of the scan signal GR. The signals SL and/or signal SR may be, for example, a common voltage VCOM or a ground voltage GND, but are not limited thereto.

When the scan driving element 51 in the electronic device 300 fails, but the scan driving element 52 continues to function normally, the electronic device 300 is in a failure state (i.e., the second condition). In this case, the signals GON_L and XGON_R are, for example, at a low voltage level VL, while the signals XGON_L and GON_R are, for example, at a high voltage level VH. This causes the switch elements SW3, SW4, SW6, and SW7 to be turned on, and the switch elements SW1, SW2, SW5, and SW8 to be turned off. Consequently, the scan signal GR generated or provided by the scan driving element 52 may be transmitted to both scan lines G1 and G2 through the switch elements SW4 and SW3. In other words, when the scan driving element 51 in the electronic device 300 fails, but the scan driving element 52 continues to function normally, the electronic device 300 is in a failure state (i.e., the second condition). The switch element SW3 is turned on to transmit the scan signal GR to the scan line G1. The scan signal GR is not generated or provided by the scan driving element 51 but is generated or provided by the scan driving element 52. When the scan driving element 51 in the electronic device 300 fails, but the scan driving element 52 continues to function normally, the electronic device 300 is in a failure state (i.e., the second condition). Since the switch element SW5 is turned off and the switch element SW6 is turned on, the data signal D1S generated or provided by the data driving element 61 is not transmitted to the pixels (e.g., the pixel P1) located in the first region 41. Instead, the signal SL may be transmitted to the data line D1 through the switch element SW6. Since the signal SL is, for example, at a VCOM voltage or ground voltage GND, the pixels (e.g., pixel P1) located in the first region 41 display a black image.

Additionally, since the switch element SW7 is turned on and the switch element SW8 is turned off, the data signal D2S generated by the data driving element 62 may be transmitted to the data line D2 through switch element SW7. The voltage range of the data signal D2S is from VdataL to VdataH, so the pixels P2 located in the second region 42 can display the image normally.

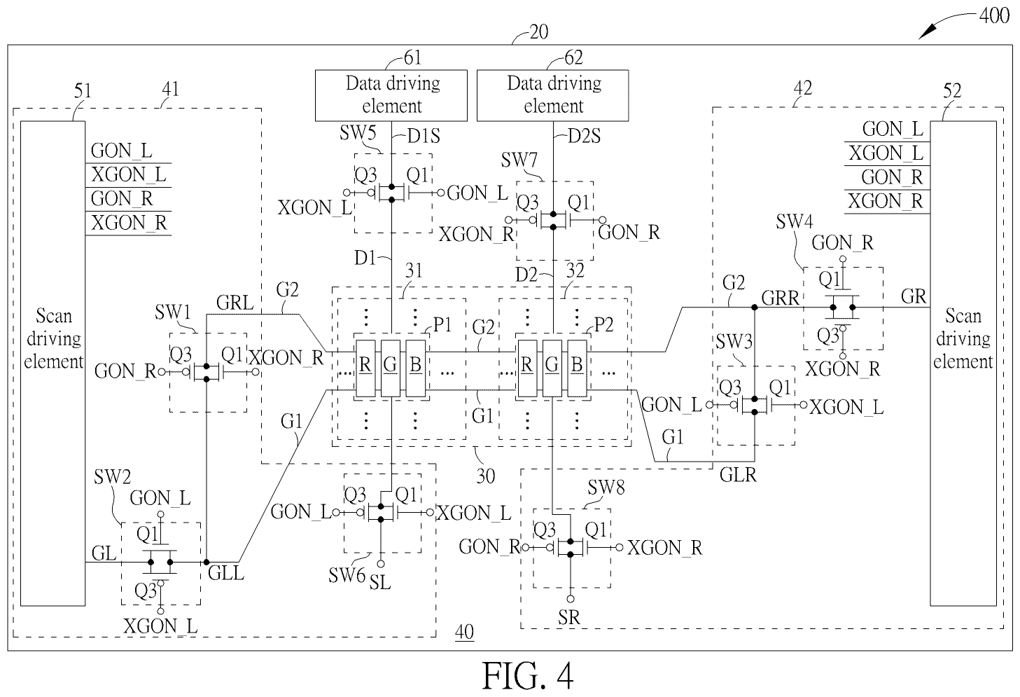

The above embodiment takes the case when the scan driving element 51 fails, but the scan driving element 52 continues to function normally in the electronic device 300 as an example. A person skilled in the art can derive the operations when the scan driving element 52 of the electronic device 300 fails, but the scan driving element 51 continues to function normally based on the above description. Additionally, each switch element SW1 to SW8 in the aforementioned embodiment includes two N-type transistors Q1 and Q2 and two P-type transistors Q3 and Q4. The two N-type transistors Q1 and Q2 are electrically connected in a dual-gate structure, and the two P-type transistors Q3 and Q4 are electrically connected in another dual-gate structure, but the present disclosure is not limited thereto. Please refer to FIG. 4, which is a schematic diagram of the electronic device 400 in another embodiment of the present disclosure. The difference between the electronic device 400 and the electronic device 300 lies in the fact that each switch element SW1 to SW8 of the electronic device 400 has an N-type transistor Q1 and a P-type transistor Q3 electrically connected in a single-gate structure. Except for the above differences, the circuit structure and operation mode of the electronic device 400 are the same as those of the electronic device 300, and therefore will not be described in detail.

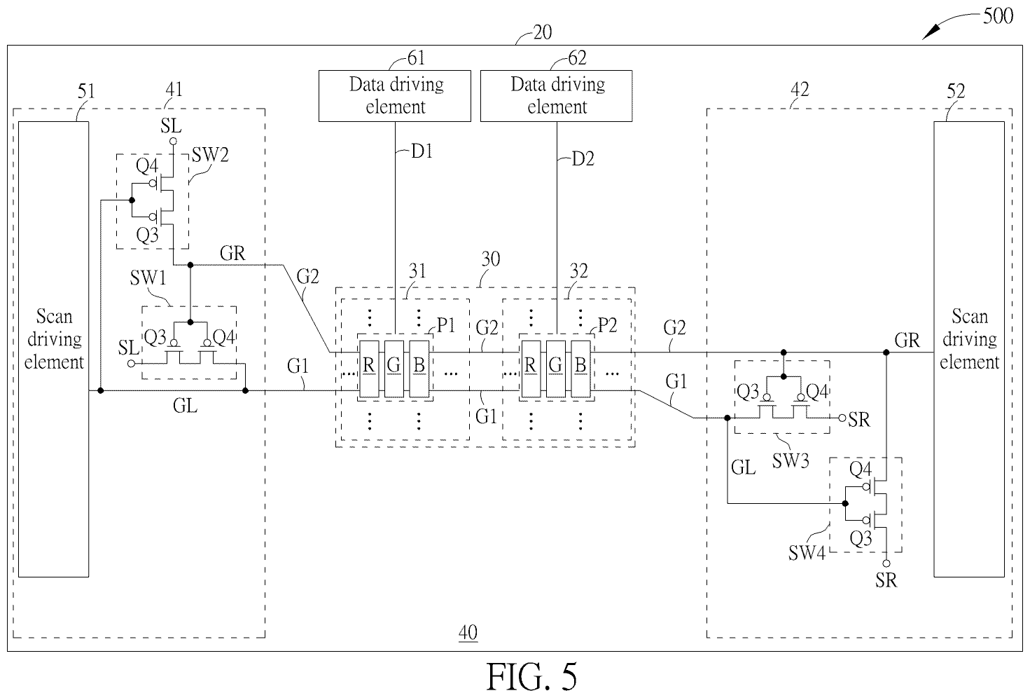

Please refer to FIG. 5, which is a schematic diagram of an electronic device 500 in another embodiment of the present disclosure. The electronic device 500 may be a display device and can comprise a substrate 20, a scan driving element 51, a scan line G1, switch elements SW1 to SW4, a scan driving element 52, and a scan line G2, but is not limited thereto. The substrate 20 has an active area 30 and a peripheral area 40 adjacent to the active area 30. In this embodiment, the peripheral area 40 is an area on the substrate 20 other than the active area 30. The electronic device 500 may further comprise a plurality of pixels (e.g., pixels P1 and P2) disposed on the active area 30, and the data driving elements 61 and 62 disposed on the peripheral area 40. The pixel P1 is, for example, disposed on the first region 31 of the active area 30 and electrically connected to the data driving element 61 through the data line D1. The pixel P2 is, for example, disposed on the second region 32 of the active area 30 and electrically connected to the data driving element 62 through the data line D2. The structure of the plurality of pixels disposed on the active area 30 of the electronic device 500 may be the same as the structure of the plurality of pixels of the electronic device 100 (as shown in FIG. 1C), and will not be described in detail herein.

The scan driving element 51 is disposed on the first region 41 of the peripheral area 40, while the scan driving element 52 is disposed on the second region 42 of the peripheral area 40. The scan driving element 51 is configured to generate the scan signal GL and transmit the scan signal GL to the sub-pixels R, G, and B of the pixel P1 in the first region 31 of the active area 30 through the scan line G1, but is not limited thereto. The scan line G1 is electrically connected to the scan driving element 51, while the scan line G2 is electrically connected to the scan driving element 52. The scan driving element 52 is configured to generate the scan signal GR and transmit the scan signal GR to the sub-pixels R, G, and B of the pixel P2 in the second region 32 of the active area 30 through the scan line G2, but is not limited thereto. The scan line G1 may extend from the first region 41 of the peripheral area 40 to the first region 31 and the second region 32 of the active area 30, and the scan line G2 may extend from the second region 42 of the peripheral area 40 to the second region 32 and the first region 31 of the active area 30. In addition, although FIG. 5 only illustrates two scan lines G1 and G2 and a corresponding row of pixels (including the pixels P1 and P2), those skilled in the art may be able to understand from the description of the present disclosure that the embodiment of FIG. 5 may be extended to a situation where the electronic device 500 comprises more scan lines and more rows of pixels.

The switch elements SW1 and SW2 of the electronic device 500 are disposed on the first region 41 of the peripheral area 40 and electrically connected to the scan line G1, while the switch elements SW3 and SW4 of the electronic device 500 are disposed on the second region 42 of the peripheral area 40 and electrically connected to the scan line G2. One end of the switch element SW1 is electrically connected to an external signal source to receive the signal SL, the other end of the switch element SW1 is electrically connected to the scan line G1, and the control end of the switch element SW1 is electrically connected to the scan line G2. One end of the switch element SW2 is electrically connected to the external signal source to receive a signal SL, the other end of the switch element SW2 is electrically connected to the scan line G2, and the control end of the switch element SW2 is electrically connected to the scan line G1. One end of the switch element SW3 is electrically connected to the external signal source to receive the signal SR, the other end of the switch element SW3 is electrically connected to the scan line G1, and the control end of the switch element SW3 is electrically connected to the scan line G2. One end of the switch element SW4 is electrically connected to the external signal source to receive the signal SR, the other end of the switch element SW4 is electrically connected to the scan line G2, and the control end of the switch element SW4 is electrically connected to the scan line G1. Under some conditions (e.g., failure of the opposite scan driving element), the signals SL or SR serve as scan signals, and the signals SL and SR may be provided by the external signal source.

Each of the switch elements SW1 to SW4 includes P-type transistors Q3 and 04 that are electrically connected in a dual-gate structure, and a control end of each of the switch elements SW1 to SW4 is formed by the gates of the P-type transistors Q3 and Q4. In other embodiments of the disclosure, the switch elements SW1 to SW4 of the electronic device 500 may comprise a single P-type transistor, replacing the dual-gate structure shown in FIG. 5 with a single-gate structure.

TABLE 3

| | | Failure condition |
|---|---|---|
| Signal or | | (the scan driving |
| component | Normal condition | element 51 failed) |
| GL | VL to VH | SL or SR (VH) |
| GR | VL to VH | VL to VH |
| SL | VL | VH |
| SR | VL | VH |
| D1 | VdataL to VdataH | GND |
| D2 | VdataL to VdataH | VdataL to VdataH |
| SW1 and SW3 | OFF(when GR = VH); | ON |
| | ON(when GR = VL) | |
| SW2 and SW4 | ON(when GL = VL); | OFF |
| | OFF(when GL = VH) | |

Taking the electronic device 500 as an example, let's illustrate the scenarios where the scanning driver component 51 fails and where both scanning driver components 51 and 52 continue to function normally. Please refer to Table 3. When both scan driving elements 51 and 52 in the electronic device 500 continue to function normally, the electronic device 500 is in a normal state (i.e., the first condition). The signals SL and SR are, for example, at the low voltage level VL, and the scan signals GL and GR are output from the scan driving elements 51 and 52, respectively, and their voltages are between VH and VL. At this time, when the voltage provided by the scan signal GL is at the high voltage level VH, the switch elements SW2 and SW4 are, for example, turned off. When the voltage provided by the scan signal GR is at the high voltage level VH, the switch elements SW1 and SW3 are, for example, turned off. At this time, the pixels (e.g., P1) located in the first region 31 of the active area 30 are, for example, driven by the scan driving element 51, and the pixels (e.g., P2) located in the second region 32 of the active area 30 are, for example, driven by the scan driving element 52.

When the scan driving element 51 in the electronic device 500 fails, but the scan driving element 52 continues to function normally, the electronic device 500 is in a failure state (i.e., the second condition). The signals SL and SR are both, for example, at the high voltage level VH, and the scan signal GR may be output from the scan driving element 52, for example, and its voltage is between VH and VL. When the voltage provided by the scan signal GR is at the low voltage level VL, the switch elements SW1 and SW3 are turned on, and the signal SL is transmitted to the scan line G1 via the switch element SW1, and the signal SR is transmitted to the scan line G1 via the switch element SW3. When the voltage provided by the scan signal GR is at the low voltage level VL, and the signals SL and SR are both, for example, at the high voltage level VH, the switch elements SW2 and SW4 are, for example, turned off. Since the scan driving element 52 is not failed, it can provide the scan signal GR to the scan line G2, and the voltage of the scan signal GR is between VH and VL. When the scan driving element 51 in the electronic device 500 fails, but the scan driving element 52 continues to function normally, the electronic device 500 is in a failure state (i.e., the second condition). Since the data line D1 is, for example, at the ground voltage GND, the pixel P1 located in the first region 41 of the active area 30 displays black, for example, and since the data line D2 can transmit a data voltage with a voltage range of VdataL to VdataH, the pixel P2 located in the second region 42 can display the image normally. When the scan driving element 51 in the electronic device 500 fails, but the scan driving element 52 continues to function normally, the electronic device 500 is in a failure state (i.e., the second condition), and the pixels (e.g., P1) located in the first region 41 of the active area 30 and the pixels (e.g., P2) located in the second region 31 of the active area 30 are, for example, driven by the scan driving element 52.

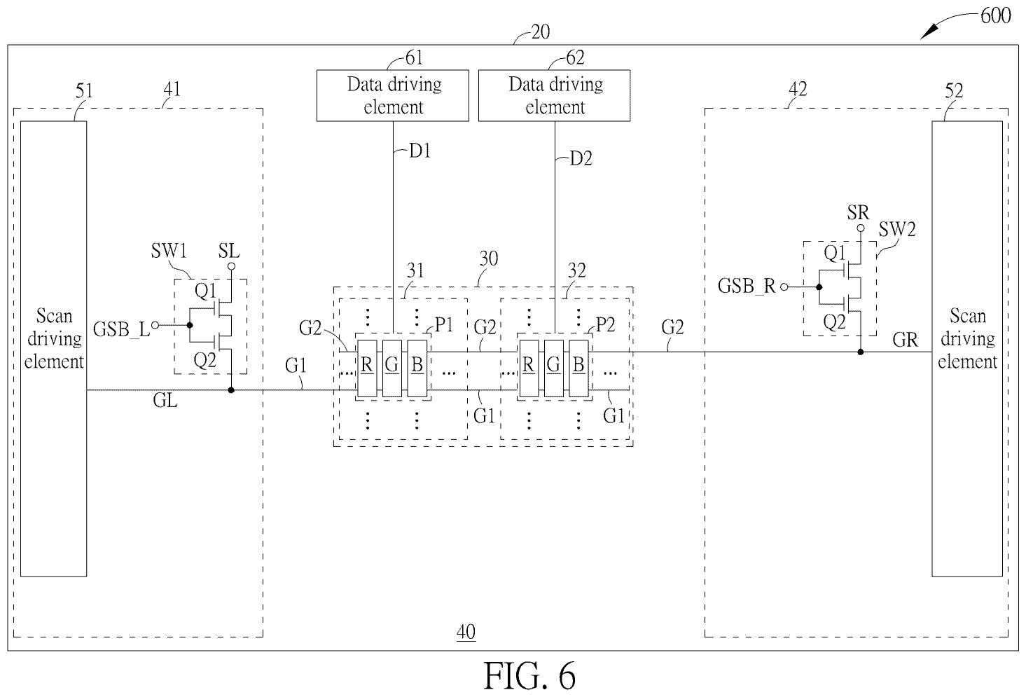

Please refer to FIG. 6, which is a schematic diagram of an electronic device 600 in another embodiment of the present disclosure. The electronic device 600 may be a display device and can comprise a substrate 20, a scan driving element 51, a scan line G1, switch elements SW1 and SW2, a scan driving element 52, and a scan line G2. The substrate 20 has an active area 30 and a peripheral area 40 adjacent to the active area 30. In this embodiment, the peripheral area 40 is an area on the substrate 20 other than the active area 30. The electronic device 600 may further comprise a plurality of pixels (e.g., pixels P1 and P2) disposed on the active area 30, and data driving elements 61 and 62 disposed on the peripheral area 40. The arrangement of the data driving elements 61 and 62, the scan driving elements 51 and 52, and the pixels (e.g., pixels P1 and P2) of the electronic device 600 may be the same as that of the electronic device 500, and will not be described in detail herein.

The switch element SW1 of the electronic device 600 is disposed on the first region 41 of the peripheral area 40 and electrically connected to the scan line G1, while the switch element SW2 of the electronic device 600 is disposed on the second region 42 of the peripheral area 40 and electrically connected to the scan line G2. One end of the switch element SW1 is electrically connected to an external signal source to receive the signal SL, the other end of the switch element SW1 is electrically connected to the scan line G1, and the control end of the switch element SW1 is used to receive the signal GSB_L. One end of the switch element SW2 is electrically connected to an external signal source to receive the signal SR, the other end of the switch element SW2 is electrically connected to the scan line G2, and the control end of the switch element SW2 is used to receive the signal GSB_R. The signals SL, SR, GSB_L, and GSB_R may be provided by an external signal source, for example.

The switch elements SW1 and SW2 each have N-type transistors Q1 and Q2 electrically connected in a dual-gate structure, and the control ends of the switch elements SW1 and SW2 are constituted by the gates of their N-type transistors Q1 and Q2. In other embodiments of the present disclosure, the switch elements SW1 and SW2 of the electronic device 600 may comprise a single N-type transistor, and a single-gate structure is substituted for the dual-gate structure in FIG. 6.

TABLE 4

| Signal or | Normal | Failed on | Failed on |
|---|---|---|---|
| component | condition | left side | right side |
| GSB_L | VL | VH | VL |
| GSB_R | VL | VL | VH |
| GL | VL to VH | SL (VH) | VL to VH |
| GR | VL to VH | VL to VH | SR (VH) |
| SL | VL | VH | VL |
| SR | VL | VL | VH |
| SW1 | OFF | ON | OFF |
| SW2 | OFF | OFF | ON |
| D1 | VdataL to VdataH | GND | VdataL to VdataH |
| D2 | VdataL to VdataH | VdataL to | GND |
| | | VdataH | |

The following describes three scenarios: when both scan driving elements 51 and 52 of the electronic device 600 continue to function normally, when the scan driving element 51 fails but the scan driving element 52 continues to function normally, and when the scan driving element 52 fails but the scan driving element 51 continues to function normally. Please refer to Table 4. When both scan driving elements 51 and 52 of the electronic device 600 continue to function normally, the electronic device 600 is in a normal state (i.e., the first condition). The signals SL and SR are, for example, at the low voltage level VL, and the scan signals GL and GR are output from the scan driving elements 51 and 52, respectively, and their voltages are between VH and VL. In the normal state (i.e., the first condition), the switch elements SW1 and SW2 are, for example, both turned off. The pixels (e.g., pixel P1) located in the first region 31 of the active area 30 are, for example, driven by the scan driving element 51, and the pixels (e.g., pixel P2) located in the second region 32 of the active area 30 are, for example, driven by the scan driving element 52.

When the scan driving element 51 in the electronic device 600 fails, but the scan driving element 52 continues to function normally, the electronic device 600 is in a failure state (i.e., the second condition). The signals SL and GSB_L are, for example, at the high voltage level VH, and the signals SR and GSB_R are, for example, at the low voltage level VL. As a result, the switch element SW1 is turned on, while the switch element SW2 is turned off. The voltage level of the scan signal GL may be equal to the voltage level of the signal SL (i.e., the high voltage level VH). At this time, the data line D1 is, for example, at the ground voltage GND, so the pixel P1 will display black. Since the data line D2 can transmit a data voltage with a voltage range of VdataL to VdataH, the pixel P2 can still display normally.

Additionally, when the scan driving element 52 in the electronic device 600 fails, but the scan driving element 51 continues to function normally, the electronic device 600 is in a failure state (another second condition). The signals SR and GSB_R are, for example, at the high voltage level VH, and the signals SL and GSB_L are, for example, at the low voltage level VL. As a result, the switch element SW2 is turned on, while the switch element SW1 is turned off. The voltage level of the scan signal GR may be equal to the voltage level of the signal SR (i.e., the high voltage level VH). At this time, the data line D2 is, for example, at the ground voltage GND, so the pixel P2 will display black. Since the data line D1 can transmit a data voltage with a voltage range of VdataL to VdataH, the pixel P1 can still display normally.

The electronic device of the present disclosure may be a display device, and the two regions of its active area may be driven by different driving elements. If one of the driving elements fails, the scan signal originally generated by the failed driving element can be generated by other components of the electronic device. Consequently, when the driving element for a certain region of the active area fails, the disclosed electronic device may display a black screen, thereby improving the user's viewing experience.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An electronic device, comprising:
a substrate, comprising an active area and a peripheral area adjacent to the active area;
a first scan driving element, disposed on a first region of the peripheral area;
a first scan line, electrically connected to the first scan driving element; and
a first switch element, disposed on the peripheral area and electrically connected to the first scan line;
wherein when the electronic device is under a first condition, the first scan driving element provides a first scan signal to the first scan line; and
wherein when the electronic device is under a second condition, the first switch element is turned on to transmit a second scan signal to the first scan line.

2. The electronic device of claim 1, further comprising:
a first data driving element, disposed on the peripheral area;
a second data driving element, disposed on the peripheral area;
a first data line, extending from the peripheral area to a first region of the active area, and electrically connected to the first data driving element; and
a second data line, extending from the peripheral area to a second region of the active area, and electrically connected to the second data driving element;
wherein the second scan signal is provided by one of the first data driving element and the second data driving element.

3. The electronic device of claim 2, further comprising:
a second switch element, disposed on the first region of the peripheral area, and electrically connected between the first scan driving element and the first scan line;
wherein a signal at a control end of the second switch element is provided by one of the first data driving element and the second data driving element.

4. The electronic device of claim 1, further comprising:
a second scan driving element, disposed on a second region of the peripheral area; and
a second scan line, extending from the second region of the peripheral area to the active area, and having one end electrically connected to the second scan driving element;
wherein the second scan signal is provided by the second scan driving element.

5. The electronic device of claim 4, further comprising:
a second switch element, disposed on the first region of the peripheral area, and electrically connected between the first scan line and the first scan driving element, wherein a signal at a control end of the second switch element is provided by the second scan driving element.

6. The electronic device of claim 1, wherein the second scan signal is provided to the first scan line by an external signal source.

7. The electronic device of claim 6, further comprising:
a second scan driving element, disposed on a second region of the peripheral area; and
a second scan line, electrically connected to the second scan driving element;
wherein a control end of the first switch element is electrically connected to the second scan line.

8. The electronic device of claim 7, further comprising:
a second switch element, disposed on the first region of the peripheral area, having a first end electrically connected to the second scan line, a control end electrically connected to the first scan line, and a second end electrically connected to the external signal source.

9. The electronic device of claim 1, further comprising:
a second scan driving element, disposed on a second region of the peripheral area;
a plurality of first pixels, disposed on a first region of the active area;
a plurality of second pixels, disposed on a second region of the active area;
wherein when the electronic device is under the first condition, the plurality of first pixels are driven by the first scan driving element, and the plurality of second pixels are driven by the second scan driving element; and
wherein when the electronic device is under the second condition, the plurality of second pixels are driven by the second scan driving element, and the first switch element is turned on to transmit the second scan signal to the first scan line to turn on transistors in the plurality of first pixels.

10. The electronic device of claim 9, wherein when the electronic device is under the second condition, the plurality of first pixels are driven by the second scan driving element.

11. A display device, comprising:
a substrate, comprising an active area and a peripheral area adjacent to the active area;
a first scan driving element, disposed on a first region of the peripheral area;
a first scan line, electrically connected to the first scan driving element; and
a first switch element, disposed on the peripheral area and electrically connected to the first scan line;
wherein when the display device is under a first condition, the first scan driving element provides a first scan signal to the first scan line; and
wherein when the display device is under a second condition, the first switch element is turned on to transmit a second scan signal to the first scan line.

12. The display device of claim 11, further comprising:
a first data driving element, disposed on the peripheral area;
a second data driving element, disposed on the peripheral area;
a first data line, extending from the peripheral area to a first region of the active area, and electrically connected to the first data driving element; and
a second data line, extending from the peripheral area to a second region of the active area, and electrically connected to the second data driving element;
wherein the second scan signal is provided by one of the first data driving element and the second data driving element.

13. The display device of claim 12, further comprising:
a second switch element, disposed on the first region of the peripheral area, and electrically connected between the first scan driving element and the first scan line;
wherein a signal at a control end of the second switch element is provided by one of the first data driving element and the second data driving element.

14. The display device of claim 11, further comprising:
a second scan driving element, disposed on a second region of the peripheral area; and
a second scan line, extending from the second region of the peripheral area to the active area, and having one end electrically connected to the second scan driving element;
wherein the second scan signal is provided by the second scan driving element.

15. The display device of claim 14, further comprising:
a second switch element, disposed on the first region of the peripheral area, and electrically connected between the first scan line and the first scan driving element, wherein a signal at a control end of the second switch element is provided by the second scan driving element.

16. The display device of claim 11, wherein the second scan signal is provided to the first scan line by an external signal source.

17. The display device of claim 16, further comprising:
a second scan driving element, disposed on a second region of the peripheral area; and
a second scan line, electrically connected to the second scan driving element;
wherein a control end of the first switch element is electrically connected to the second scan line.

18. The display device of claim 17, further comprising:
a second switch element, disposed on the first region of the peripheral area, having a first end electrically connected to the second scan line, a control end electrically connected to the first scan line, and a second end electrically connected to the external signal source.

19. The display device of claim 11, further comprising:
a second scan driving element, disposed on a second region of the peripheral area;
a plurality of first pixels, disposed on a first region of the active area;
a plurality of second pixels, disposed on a second region of the active area;
wherein when the display device is under the first condition, the plurality of first pixels are driven by the first scan driving element, and the plurality of second pixels are driven by the second scan driving element; and
wherein when the display device is under the second condition, the plurality of second pixels are driven by the second scan driving element, and the first switch element is turned on to transmit the second scan signal to the first scan line to turn on transistors in the plurality of first pixels.

20. The display device of claim 19, wherein when the display device is under the second condition, the plurality of first pixels are driven by the second scan driving element.
